(19) United States
(12) Patent Application Publication
(10) Pub. No.: US 2025/0003548 A1
(43) Pub. Date: Jan. 2, 2025

(54) COMPUTER MONITOR STAND

(71) Applicant: MOBILE PIXELS INC., Irwindale, CA (US)

(72) Inventors: Xiaoliang Yao, Burlington, MA (US); Wenglong Ng, Burlington, MA (US)

(21) Appl. No.: 18/343,300

(22) Filed: Jun. 28, 2023

(51) Int. Cl. F16M 11/24; F16M 11/04; F16M 11/20

(52) U.S. Cl. CPC F16M 11/24; F16M 11/046; F16M 11/2021

(57) ABSTRACT

According to at least one aspect of the present disclosure, a stand for one or more monitors is presented, the stand comprising a base; a support pillar coupled to the base; a first hinge coupled between a first monitor support and a second monitor support, the first monitor support being slidably coupled to the support pillar; and a second hinge coupled to the first monitor support and configured to allow the first monitor support to pivot through a plurality of positions relative to the support pillar.

### BACKGROUND

Displays are devices used to display information to a user. Common displays include the standard computer monitor, which is a display designed to connect to a computer and display graphical information to the user based on the functions, programming, and general operation of the computer. Computer monitors come in various sizes and can have differing characteristics, such as refresh rates, color depth, input/output (IO) interfaces, and so forth.

### SUMMARY

According to at least one aspect of the present disclosure, a stand for one or more monitors is presented, comprising a base; a support pillar coupled to the base; a first hinge coupled between a first monitor support and a second monitor support, the first monitor support being slidably coupled to the support pillar; and a second hinge coupled to the first monitor support and configured to allow the first monitor support to pivot through a plurality of positions relative to the support pillar.

In some examples, the first monitor support is configured to slidably couple to a first universal adapter and the second monitor support is configured to slidably couple to a second universal adapter. In various examples, the first universal adapter includes one or more connections configured to be fixedly coupled to a first monitor to slidably couple the first monitor to the first monitor support. In many examples, the second universal adapter includes one or more connections configured to be fixedly coupled to a second monitor and slidably couple the second monitor to the second monitor support.

In some examples, the first monitor support is configured to be selectively fixed in one or more positions of a plurality of positions between an uppermost position along the support pillar and a lowest position along the support pillar. In various examples, a position of the second monitor support depends on a respective position of the first monitor support from among the plurality of positions. In many examples, the second monitor support is coupled to a support bar of a support having one or more support bars; and the second hinge is coupled to a different support bar of the support having one or more support bars.

In various examples, the stand further comprises a base hinge support coupled to the base; and a support bar hingedly coupled to the base hinge support and hingedly coupled to the second monitor support. In many examples, the stand further comprises a connector coupled between the support pillar and the first monitor support, the connector being configured to slide up and down along one or more guide slots of the support pillar. In many examples, the stand further comprises a support coupled to the first hinge, the second hinge, and the support pillar, the support being in a fixed orientation relative to the first monitor support and the second monitor support.

In various examples, the support has three support bars including a first support bar, a second support bar, and a third support bar, the first support bar being coupled to the first hinge, the second support bar being coupled to the second hinge, and the third support bar being coupled to the connector. In many examples, the stand further comprises a first universal adapter coupled to the first monitor support and a second universal adapter coupled to the second monitor support, wherein the first universal adapter is configured to couple to one or more monitors within a first size range of a first plurality of different sizes, and the second universal adapter is configured to couple to one or more monitors within a second size range of a second plurality of different sizes.

According to at least one aspect of the present disclosure, a stand is presented comprising a support pillar; a base coupled to the support pillar; a first monitor support slidably coupled to the support pillar and configured to selectively maintain a vertical position of a plurality of vertical positions relative to the support pillar, the first monitor support being further configured to rotate to occupy one or more orientations between a vertical orientation and a horizontal orientation, the vertical orientation being approximately parallel to the support pillar and the horizontal orientation being approximately perpendicular to the support pillar; and a second monitor support hingedly coupled to the first monitor support.

In many examples, the second monitor support is further configured to occupy one or more orientations between the vertical orientation and the horizontal orientation. In various examples, the first monitor support includes one or more adjustment slots. In some examples, the stand further comprises a universal adapter configured to couple to a plurality of monitors of different sizes, the universal adapter being slidably coupled to the first monitor support such that the universal adapter can occupy one or more positions corresponding to the adjustment slots.

In some examples, the second monitor support includes one or more adjustment slots. In various examples, the stand further comprises a universal adapter configured to couple to a plurality of monitors of different sizes, the universal adapter being slidably coupled to the second monitor support such that the universal adapter can occupy one or more positions corresponding to the adjustment slots. In many examples, an angle of the second monitor support depends on the vertical position of the first monitor support.

In some examples, the stand further comprises a base hinge support coupled to the base; and a support bar hingedly coupled to the base hinge support and hingedly coupled to the second monitor support. In many examples, the stand further comprises a connector coupled between the first monitor support and the support pillar, wherein the connector is rigidly coupled to the first monitor support and slidably coupled to the support pillar. In various examples, the stand further comprises a support coupled between the connector and the first monitor support, the support having a plurality of support bars.

In some examples, the stand further comprises a first monitor coupled to the first monitor support and a second monitor coupled to the second monitor support.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a monitor stand according to an example;

FIG. 2 illustrates the monitor stand with two universal adapters attached to the monitor stand, according to an example;

FIG. 3 illustrates the stand from an isometric view in varying positions according to an example;

FIG. 4 illustrates the stand from a profile view in varying positions according to an example;

FIG. 5 illustrates the stand from a top-down view in varying positions according to an example;

FIG. 6 illustrates the stand in an intermediary position according to an example, with a close-up, side-view of a hinge;

FIG. 7A illustrates the stand support more than one monitor according to an example;

FIG. 7B illustrates the stand support more than one monitor according to an example;

FIG. 7C illustrates the stand support more than one monitor according to an example;

FIG. 7D illustrates the stand support more than one monitor according to an example; and

FIG. 8 illustrates a process for adjusting a stand according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving.” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Computer monitors come in various sizes. For laptop computers, the inbuilt laptop monitor often matches the dimensions of the laptop, though laptop computers may include IO ports designed to connect to independent (or standalone) computer monitors. Desktop computers, on the other hand, often do not include inbuilt monitors and instead have multiple ports or specialized hardware (such as graphics cards) designed to accommodate one or more independent monitors. Independent monitors range in size from small to large. For example, twenty-two inch monitors (22″ monitors) are one size of monitor, as are larger 32″ monitors. However, monitors may be virtually any size.

Larger monitors can display more information to the user. Users may also use multiple monitors to display more information or to allow more convenient organization of information, or for other purposes. For example, a user may position two or more monitors side-by-side so as to see more information at once than a single monitor could conveniently display.

Examples of the present disclosure include monitor stands for accommodating monitors of various sizes. The monitor stands may be equipped with universal monitor mounting mechanisms that may mount monitors of any size or of a given range of sizes. The monitor stands may be equipped with hinges that allow for the displays to be rotated and/or pivoted with respect to one another, and to be positioned at various angles for the convenience of the user. Some examples may be equipped with guide slots in the mounting mechanism that allow the user to dynamically adjust the universal monitor mounting mechanism to accommodate a monitor of a desired size. Some of the monitor stands include multiple universal monitor mounting mechanisms so that users may mount two or more monitors to the stand. In some examples, the user may mount multiple monitors of multiple different sizes to the stand.

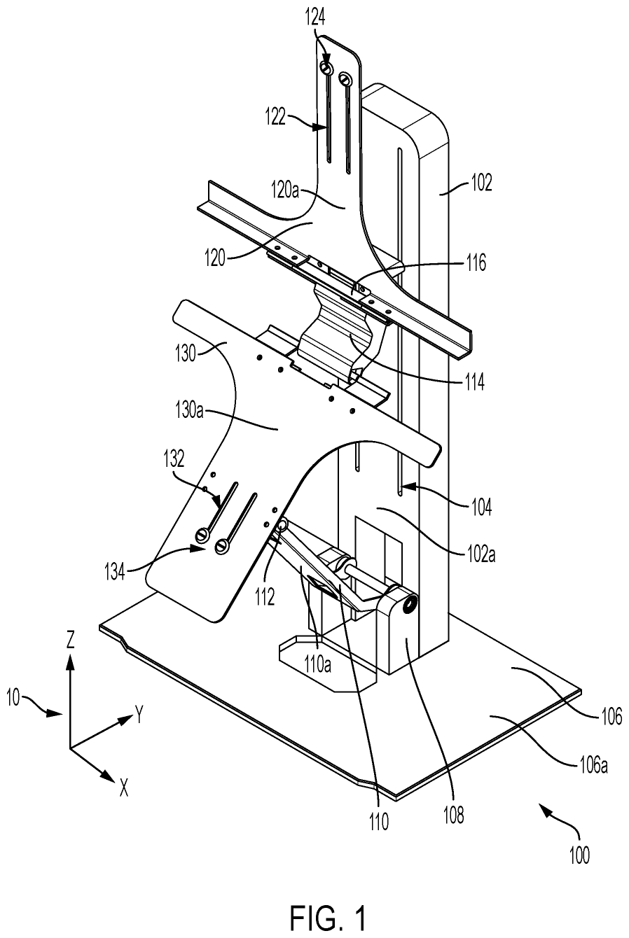

FIG. 1 illustrates a monitor stand 100 (“stand 100”) according to an example. The stand 100 can support at least two monitors of a range of sizes. For example, the stand 100 can support at least two monitors of the same size, or two monitors of different sizes. The stand 100 has adjustable monitor supports that can be placed in different configurations, as will be described in greater detail below.

The stand 100 includes a support pillar 102 having one or more guide slots 104 (“guide slots 104”). The stand 100 further includes a base 106, a base hinge support 108, a support linkage 110, and a support linkage hinge 112. The stand 100 also includes a first hinge 114 and a second hinge 116, as well as a first monitor support 120 having one or more adjustment slots 122 (“adjustment slots 122”) and fasteners 124, and a second monitor support 130 having one or more adjustment slots 132 (“adjustment slots 132”) and connection mechanisms 134. The support linkage 110 includes a support linkage face 110a. The support pillar 102 includes a support pillar face 102a. The base 106 include a base face 106a. The first monitor support 120 includes a first monitor support face 120a. The second monitor support 130 includes a second monitor support face 130a. FIG. 1 also illustrates a legend 10 having X, Y, and Z axes.

The base 106 is coupled to the support pillar 102 and to the base hinge support 108. The support pillar 102 is coupled to at least one of the monitor supports 120, 130. In the example illustrated in FIG. 1, the support pillar 102 is coupled to the first monitor support 120. The first monitor support 120 is coupled to the first hinge 114 and the second hinge 116. The first hinge 114 is further coupled to the second monitor support 130, and the second monitor support 130 is coupled to the support linkage hinge 112. The support linkage hinge 112 is coupled to the support linkage 110, and the support linkage 110 is coupled to the base hinge support 108.

The base 106 forms a platform that provides stability to the stand 100 as a whole. For example, the base 106 may have dimensions designed to prevent the stand 100 from tipping over or falling regardless of the configuration of any of the hinges or connection mechanisms, the position of the monitor supports 120, 130 or any attached monitors, and/or the type of any attached monitors.

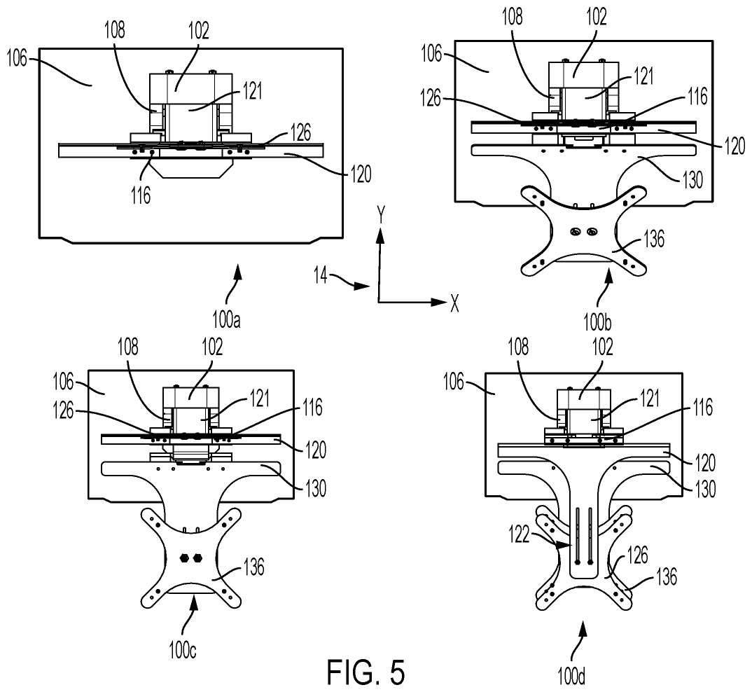

The support pillar 102 is, in some examples, slidably coupled to the first monitor support 120. The support pillar 102 has guide slots 104 configured to accommodate a portion of the first monitor support 120 such that the first monitor support 120 can slide up or down (that is, along the Z-axis of the legend 10) along the support pillar face 102a between a lowest position nearest to the base 106 (that is, at a furthest position in the negative direction of the Z-axis) and a highest position furthest from the base 106 (that is, at a furthest position in the positive direction of the Z-axis). Details of the motion of the monitor support 120, 130 will be discussed with respect to at least FIGS. 5, 6, and 7.

The base hinge support 108 is located adjacent to the support pillar 102 in some examples. The base hinge support 108 is rotatably coupled to the support linkage 110 at a first end of the support linkage 110. In some examples, the support linkage 110 rotates relative to the base hinge support 108. The base hinge support 108 may include a crossbar or similar mechanism that the support linkage 110 connects to and rotates around. The support linkage 110 is coupled to the support linkage hinge 112 at a second end of the support linkage 110. The support linkage hinge 112 is rotatably coupled to the second monitor support 130 in some examples.

In some examples, when the first monitor support 120 moves up or down (that is, along the Z-axis of the legend 10) along the guide rails 104 of the support pillar 102, the second monitor support 130 is pulled or pushed by the first monitor support 120 in a vertical direction (that is, along the Z-axis of the legend 10) via the first hinge 114. As the second monitor support 130 moves in the vertical direction, the support linkage 110 may change orientation to accommodate the movement of the second monitor support 130. In some examples, when the first monitor support 120 is at the highest position in the guide rails 104 (that is, when the first monitor support 120 is at a furthest position in the positive direction of the Z-axis), the support linkage 110 may be considered to be in a vertical position, and when the first monitor support 120 is in the lowest position in the guide rails 104 (that is, when the first monitor support 120 is at a furthest position in the negative direction of the Z-axis), the support linkage 110 may be considered to be in a horizontal position.

In many examples, the support linkage 110 is rigid. The support linkage hinge 112 and base hinge support 108 may therefore provide two points at which the support linkage 110 may pivot or rotate, allowing the second monitor support 130 to move with the first monitor support 120.

The first hinge 114 connects the first monitor support 120 to the second monitor support 130. As the first monitor support 120 moves up and down along the guide rails 104, the second monitor support 130 moves (for example, responsive to a force exerted by the first hinge 114) between a corresponding series of positions along the Z-axis. In particular, when the first monitor support 120 is at the lowest position along the Z-axis, the second monitor support 130 may be in a corresponding lowest position along the Z-axis. This lowest position of the second monitor support 130 may be referred to in some examples as a horizontal position. In the horizontal position, the plane of the second monitor support face 130a may be approximately parallel to the plane of the base face 106a. When the first support monitor 120 is at the highest position, the second monitor support 130 may be in a corresponding highest position that may be referred to in some examples as a vertical position. In the vertical position, the plane of the second monitor support face 130a may be approximately parallel to the plane of the support pillar face 102a. The second monitor support 130 may also have various intermediary positions ranging from the second monitor support face 130a being generally parallel to the support pillar face 102a to generally parallel to the base face 106a. In some examples, the first hinge 114 may have multiple axes of rotation associated with it. For example, there may be an axis of rotation associated with the first monitor support 120 and a different axis of rotation associated with the second monitor support 130.

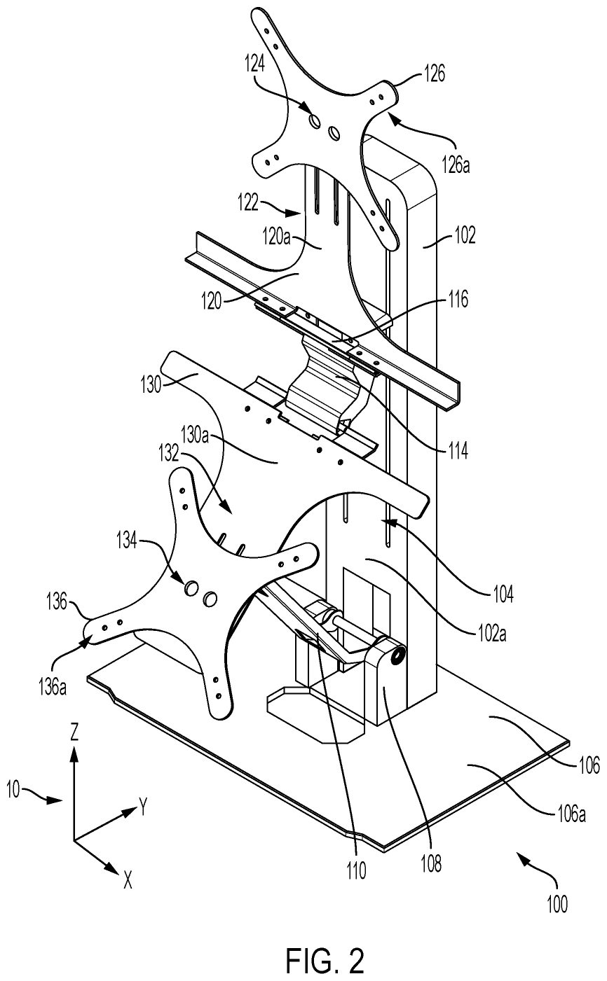

The monitor supports 120, 130 each have respective fasteners 124, 134 and adjustment slots 122, 132. The monitor supports 120, 130 hold monitors via a universal adapter that will be discussed with respect to FIG. 2. The fasteners 124, 134 may be moved in the adjustment slots 122, 132 to a desired position within the adjustment slots 122, 132. The position of the fasteners 124, 134 within the adjustment slots 122, 132 may determine the position of the universal adapter associated with a given monitor support 120, 130.

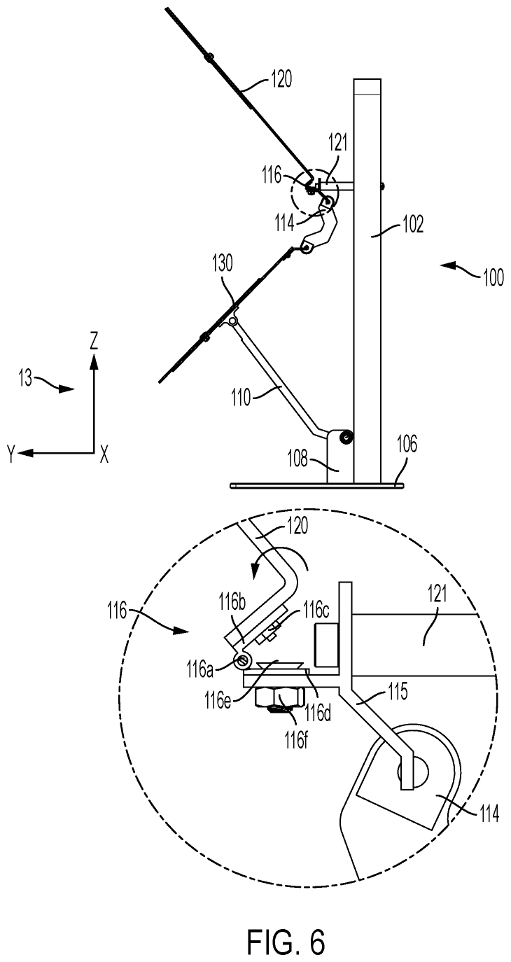

The first monitor support 120 also includes a perpendicular section that couples to the second hinge 116. The second hinge 116 allows the first monitor support 120 to pivot from a vertical position to a horizontal position. In the vertical position, the plane of the first monitor support face 120a is approximately parallel to the plane of the support pillar face 102a. In the horizontal position, the plane of the first monitor support face 120a is approximately parallel to the plane of the base face 106a. In some examples, the first monitor support 120 may have a maximum range of angles through which the first monitor support 120 can traverse between the vertical position and the horizontal position. In some examples, this range is 90 degrees, but in other examples, the range may be greater than or less than 90 degrees. The movement of the first monitor support 120 with respect to the second hinge 116 will be discussed in greater detail with respect to FIG. 6.

FIG. 2 illustrates the stand 100 with two universal adapters 126, 136 attached.

The first universal adapter 126 is coupled to the first monitor support 120 via the fasteners 124. The position of the first universal adapter 126 therefore depends on the positions of the fasteners 124 within and/or along the adjustment slots 122.

The second universal adapter 136 is coupled to the second monitor support 130 via the fasteners 134. The position of the second universal adapter 136 therefore depends on the positions of the fasteners 134 within and/or along the adjustment slots 132.

The universal adapters 126, 136 may be any sort of adapter designed to hold monitors. In some examples, the universal adapters 126, 136 may be configured to hold monitors of particular sizes or ranges of sizes. In some examples, the universal adapters 126, 136 may have respective holes or slots 126a, 136a corresponding to the locations of holes in the back of a monitor or in a mounting plate located on a monitor. By placing fasteners (for example, screws, bolts, and so forth) through the holes and/or slots 126a, 136a, the universal adapters 126, 136 may be secured to a given monitor. However, other methods of securing monitors exist as well, for example, using adhesives, adhesive magnets, or other fasteners to affix the monitor to the universal adapter. Accordingly, in various examples any type of fasteners may be used to couple (for example, fixedly couple, removably couple, and so forth) the universal adapters 126, 136 to respective monitors.

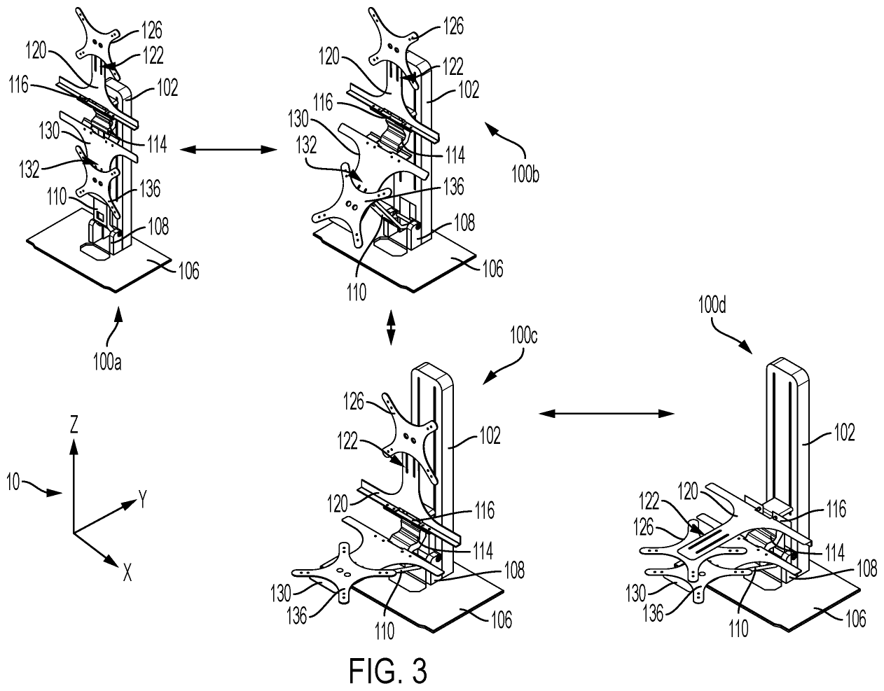

FIG. 3 illustrates, in an isometric view, the stand 100 in various positions between a fully vertical (or open) position and a fully horizontal (or closed) position according to an example. FIG. 3 includes the fully open position 100a, a first intermediary position 100b, a second intermediary position 100c, and the fully closed position 100d.

In the fully open position 100a, the stand 100 is generally arranged vertically. That is, the first monitor support 120 is vertical and the second monitor support 130 is vertical. For example, when the monitor supports 120, 130 are in the vertical position, the supports 120, 130 may be generally parallel to the support pillar 102 such that the plane of the first monitor support face 120a and the plane of the second monitor support face 130a are approximately parallel to the plane of the support pillar face 102a). In other words, the angle between the first monitor support 120 and the second monitor support 130 may be 180 degrees or approximately 180 degrees (for example, within a threshold range of degrees of 180 degrees, such as within 1 degree of 180 degrees, 5 degrees of 180 degrees, 10 degrees of 180 degrees, and so forth).

The first monitor support 120 is also positioned at or near the highest position of the guide slots 104, that is, the first monitor support 120 is positioned at or near the guide slot 104 position furthest from the base 106. In the fully open position 100a, the support linkage 110 is also in a vertical position, nested behind the second monitor support 130, between the second monitor support 130 and the support pillar 102. The first hinge 114 is also in a position that is closer to the support pillar 102 (and may, in some examples, be flush against the support pillar 102). In some examples, in positions other than the fully vertical position (for example, the positions 100b, 100c, 100d) the first hinge 114 may move so that portions or all of the first hinge 114 are further from the support pillar 102, as will be discussed with respect to the other positions.

The first monitor support 120 is shown in the vertical position in the fully open position 100a. However, the second hinge 116 is not limited in operation to folding only in the fully closed position 100d. That is, the first monitor support 120 may be placed in the horizontal position (for example, generally parallel to the base 106, such that the plane of the first monitor support face 120a is generally parallel to the plane of the base face 106a) in any of the positions discussed with respect to FIG. 3. Likewise, the second hinge 116 may occupy any intermediary position between the vertical and horizontal positions, and thus the first monitor support 120 may be placed in any intermediary position between the vertical and horizontal positions as well in any of the positions shown with respect to FIG. 3. An example of the first monitor support 120 in an intermediary position between horizontal and will be discussed with respect to FIG. 6.

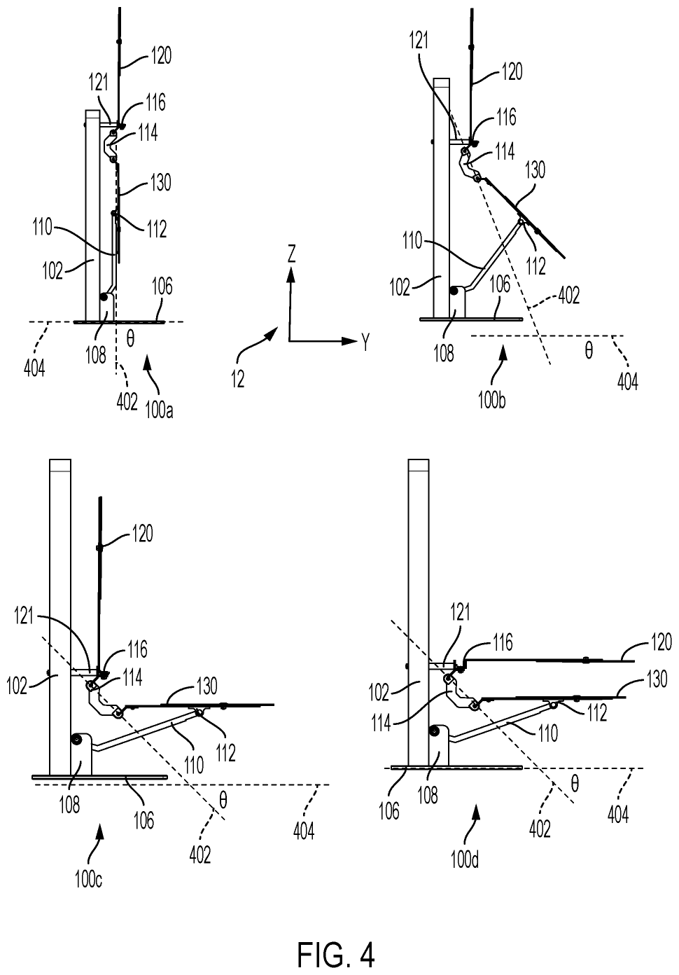

FIG. 4 shows the stand 100 of FIG. 3 in the same positions as in FIG. 3, but from a side-view rather than an isometric view. FIG. 4 includes a legend 12 having Y and Z axes. The position of the first hinge 114 changes as the second monitor support 130 is moved from vertical to horizontal position. For example, in the fully open position 100a, the first hinge 114 is oriented vertically such that the back of the first hinge 114 is parallel to the wall and the two portions where the first hinge 114 is coupled to the first monitor support 120 and second monitor support 130 are vertically aligned. By contrast, as the stand 100 switches from the fully open position 100a to the first intermediary position 100b and then to the second intermediary position 100c and/or the fully closed position 100d, the first hinge 114 shifts such that a first line 402 through the points at which the first hinge 114 couples to the first monitor support 120 and the second monitor support 130 forms an angle θ with a second line 404 that is parallel to the base 106. In some examples, θ is approximately 90 degrees in the fully open position 100a, and is approximately 45 degrees in the second intermediary position 100c and the fully closed position 100d.

In some examples, when θ is approximately 90 degrees, the second monitor support 130 will be in the vertical position, and when θ is approximately 45 degrees (or less) the second monitor support 130 will be in the horizontal position. Likewise, in some examples, the first hinge 114 will be at a highest position (that is, farthest from the base 106) when θ is approximately 90 degrees, and will be at a lowest position (that is, closest to the base 106) when θ is approximately 45 degrees (or less, for example, 35 degrees, 25 degrees, 15 degrees, or any other value).

FIG. 4 also shows a connector 121. The connector 121 is configured to couple between the first monitor support 120 and/or the second hinge 116 and the support pillar 102. The connector 121 sits within the guide slots 104 of the support pillar 102, and may be moved up or down along the Z-axis to move the first monitor support 120 (and therefore the hinges 114, 116 and second monitor support 130) up or down as well. In some examples, the connector 121 is fixedly coupled to the first monitor support 120 and/or the second hinge 116 and slidably coupled to the support pillar 102 via the guide slots 104.

FIG. 5 illustrates the stand 100 from a top-down view according to an example. In FIG. 5, the stand 100 is in the same positions as shown in FIGS. 3 and 4. FIG. 5 also includes a legend 14 having X and Y axes.

The first and second monitor supports 120, 130 are not necessarily of the same shape and size. In the example illustrated in FIG. 5, portions of the first monitor support 120 are thinner than the second monitor support 130 in the directions parallel to the X-axis. However, the monitor supports 120, 130 may also be the same size or the first monitor support 120 may be wider than the second monitor support 130 (for example, in directions parallel to the X-axis), and so forth.

In the fully closed position 100d or the intermediary positions 100b, 100c the second monitor support 130 and/or first monitor support 120 can protrude beyond the boundaries of the base 106. For example, in the fully closed position 100d, the monitor supports 120, 130 extend beyond the edge of the base 106. In some examples, the monitor support 120, 130 may not extend beyond the edge of the base 106 in some intermediary positions 100b, 100c.

FIG. 6 illustrates the stand 100 in an intermediary position according to an example, with a close-up, side-view of the second hinge 116 according to an example. FIG. 6 contains a legend 13 having a Z-axis, a Y-axis, and an X-axis (the dot indicating the positive of the X-axis is the direction emerging from the page in the direction of the view). The second hinge 116 allows the first monitor support 120 to pivot between a vertical position roughly parallel with the support pillar 102 and a horizontal position roughly parallel with the base 106. In some examples, the second hinge 116 allows the first monitor support 120 to occupy any intermediary position between the horizontal position and the vertical position as well.

The second hinge 116 includes a joint 116a, a first flange 116b, a first fastener 116c, a second flange 116d, a second fastener 116e, and a third fastener 116d. Also shown are the connector 121, the first hinge 114, and a y-shaped support 115.

The joint 116a enables the first monitor support 120 to rotate about an axis parallel to the X-axis when moving between vertical and horizontal positions. For example, the joint 116a may include at least one hinge to enable rotation about an axis parallel to the X-axis. The joint 116a may be comprised of any appropriate material, and may include a torque hinge such that, to change position, additional force is required in addition to the gravitational force applied by the first monitor support 120 and anything connected to the first monitor support 120. For example, the user may be required to apply additional force directly or indirectly to the second hinge 116 and/or to the joint 116a to change the position of the first monitor support 120.

The joint 116a is coupled to the first flange 116 and the second flange 116d. The first flange 116d can be coupled to the first monitor support 120, for example via the first fastener 116c (for example, a screw and bolt, as illustrated, though any fastening mechanism may be used). In some examples, the joint 116a is rigidly coupled to the second flange 116d and pivotably coupled to the first flange 116b. In some examples, the joint 116a is rigidly coupled to the first flange 116b and pivotably coupled to the second flange 116d. In some examples, the coupling of the joint 116a to the flanges 116b, 116d is configured such that the first monitor support 120 may pivot with respect to the joint 116a, for example, by pivoting relative to the support pillar 102.

The second flange 116d is coupled to the y-shaped support 115 by the second and third fasteners 116e, 116f. In various examples, the second fastener 116e may be a screw and the third fastener 116f may be a bolt. In other examples, other fastening mechanism can be used. The second fastener 116e, in some examples, includes a concave indentation to accommodate the first fastener 116c in the vertical position (for example, the fully open position 100a) and/or in intermediary positions close to the vertical position. Alternatively, in some examples, the first fastener 116c rests atop the second fastener 116e in the vertical position and/or generally vertical positions (that is, positions close to the vertical position) of the first monitor support 120.

The y-shaped support 115 is includes several support bars, in some examples formed from a single piece of material. The y-shaped support 115 is coupled to the second flange 116d, the connector 121, and the first hinge 114. In some examples the y-shaped support 115 has at least three support bars including a first support bar coupled to the second flange 116d, a second support bar coupled to the connector 121, and a third support bar coupled to the first hinge 114. In some examples the y-shaped support 115 is rigidly coupled to at least one of the second flange 116d, the connector 121, and/or the first hinge 114. In some examples, the y-shaped support 115 is pivotably coupled to the first hinge 114. In preferred embodiments, the y-shaped support 115 is pivotably coupled to the first hinge 114 so that at least some portion of the first hinge 114 may move toward and/or away from the support pillar 102 depending on the position of the first monitor support 120 and/or second monitor support 130.

In the foregoing examples, rotation and pivoting may be clockwise or anticlockwise for any joint or hinge.

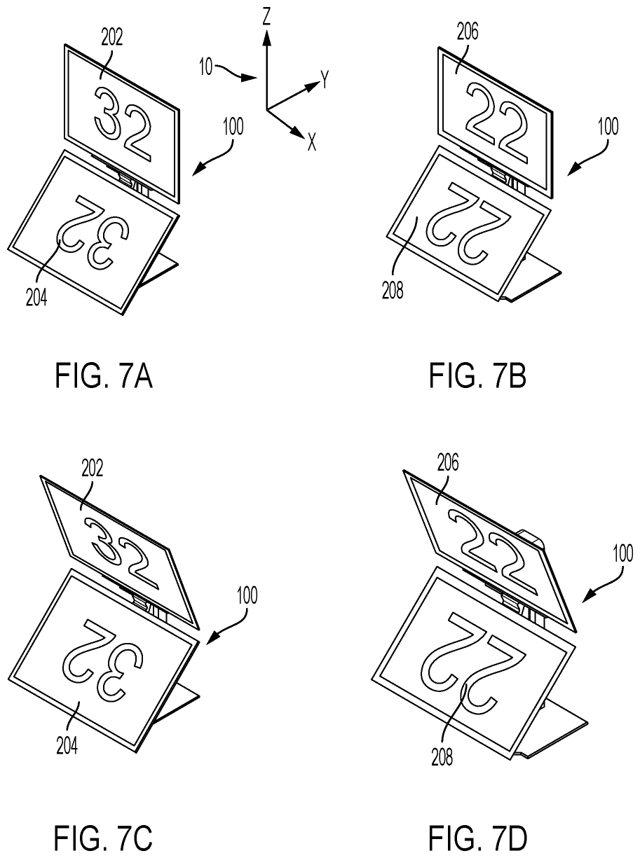

FIGS. 7A, 7B. 7C, and 7D illustrates the stand 100 supporting monitors according to various examples.

FIG. 7A illustrates the stand 100 holding a first 32 inch monitor 202 and a second 32 inch monitor 204. The first monitor support 120 is coupled to the first 32-inch monitor 202, and the second monitor support 130 is coupled to the second 32-inch monitor 204. In some examples, the first monitor support 120 is coupled to the first 32-inch monitor 202 via the first universal adapter 126. In some examples, the second monitor support 130 is coupled to the second 32-inch monitor 204 via the second universal adapter 136. In various examples, the coupling of the first and second 32-inch monitors 202, 204 to the monitor supports 120, 130 is rigid coupling, whether direct or indirect.

FIG. 7B illustrates the stand 100 holding a first 22-inch monitor 206 and a second 22-inch monitor 208. The first 22-inch monitor 206 is coupled to the first monitor support 120, and the second 22-inch monitor 208 is coupled to the second monitor support 130. In some examples, the first monitor support 120 is coupled to the first 22-inch monitor 206 via the first universal adapter 126. In some examples, the second monitor support 130 is coupled to the second 22-inch monitor 208 via the second universal adapter 136.

In both FIGS. 7A and 7B, the first monitor support 120 is in the vertical position (for example, generally parallel to the support pillar 102). FIGS. 7C and 7D are identical to FIGS. 7A and 7B, respectively except that, in both, the first monitor support 120 is shown in an intermediary position between the vertical position and the horizontal position. In all of FIGS. 7A, 7B, 7C, and 7D the second monitor support 130 is in an intermediary position between the vertical and horizontal positions.

The monitors 202, 204, 206, 208 of FIGS. 7A-7D need not be the same size. For example, in FIG. 7A the first 32-inch monitor 202 may be a different size in alternative examples (for example, 21 inches, 48 inches, and so forth) and may be the same size or a different size as the second 32-inch monitor 204 (for example, 16 inches, 28 inches, and so forth). The monitors attached to the stand 100 do not need to be the same size as each other, and may be any size. Depending on the particular dimensions of the stand 100, there may be limits (for example, a maximum size) on the monitors that can be attached to the stand 100. For example, a small version of the stand 100 may not be able to support monitors over a threshold size.

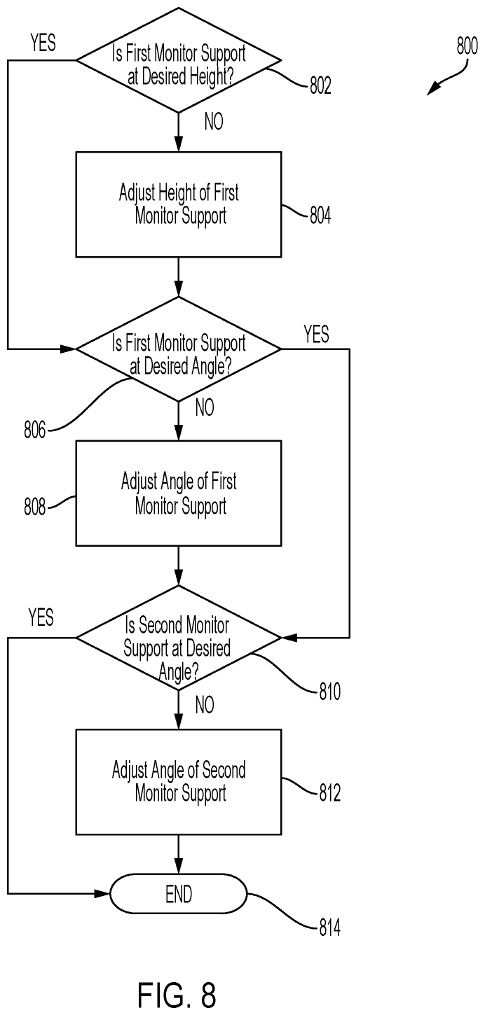

FIG. 8 illustrates a process 800 for adjusting the stand 100 according to an example. For example, the process 800 may include a method of providing instructions to a user to adjust the stand 100.

At act 802, the user is instructed to determine whether the first monitor support 120 is at a desired height. For example, a user may desire that the first monitor support 120 be at a relatively high position (for example, close to the top of the support pillar 102) or a relatively low position (for example, close to the bottom of the support pillar 102, near the base 106), or in an intermediate position between the two positions. If the first monitor support 120 is at the desired height (802 YES), the process 800 continues to act 806. If the first monitor support 120 is not at a desired height (802 NO), the process 800 continues to act 804.

At act 804, the user is instructed to adjust the height of the first monitor support 120. For example, the position of the connector 121 in the guide slots 104 may be adjusted or changed, such that the first monitor support 120 moves up or down relative to the support pillar 102. The connector 121 does not need to be directly manipulated, but may be caused to move through the application of force to another part of the stand 100, such as the first monitor support 120. For example, the user may be instructed to adjust the position of the connector 121 in the guide slots 104, thereby moving the first monitor support 120 up or down. In some examples, the height of the second monitor support 130 is also adjusted when adjusting the height of the first monitor support 120. For example, the first monitor support 120 and the second monitor support 130 may be coupled in a fixed or semi-fixed manner, such that when one support moves the other support also moves. The connector 121 and/or first monitor support 120 may remain in place once the first monitor support 120 has been moved to the desired height, so that the first monitor support 120 remains at the desired height until and/or unless the height is later adjusted. The process 800 then continues to act 806.

At act 806, the user is instructed to determine if the first monitor support 120 is at a desired angle. For example, the user may determine if the first monitor support 120 is at the desired angle. If it is determined that the first monitor support 120 is at the desired angle (806 YES), the process 800 continues to act 810. If it is determined that the first monitor support 120 is not at a desired angle (806 NO), the process 800 continues to act 808.

At act 808, the user is instructed to adjust angle of the first monitor support 120. For example, the first monitor support 120 may be tilted forward or backward via the second hinge 116 about the longitudinal axis of the second hinge 116. In some examples, the first monitor support 120 may be titled to any angle between the horizontal position and the vertical position. For example, the first monitor support 120 may be able to rotate from the vertical position about the longitudinal axis of the second hinge 116 to any other position (such as the horizontal position or an intermediary position) within a range of degrees. For example, the first monitor support 120 may be able to rotate up to 90 degrees, 80 degrees, 110 degrees, or any other amount. In some examples, the angle of the first monitor support 120 can be locked or fixed once the user has placed the first monitor support 120 at the desired angle. In some examples, the first monitor support 120 will remain at the desired angle until and/or unless the angle is again adjusted. The process 800 then continues to act 810.

At act 810, the user is instructed to determine if the second monitor support 130 is at a desired angle. For example, the user may determine if the second monitor support 130 is at a desired angle. If the second monitor support 130 is determined to be at a desired angle (810 YES), the process 800 continues to act 814. If the second monitor support 130 is determined to not be at a desired angle (810 NO), the process 800 continues to act 812.

At act 812, the user is instructed to adjust the angle of the second monitor support 130. For example, the user may adjust the angle of the second monitor support 130. The second monitor support 130 may be rotated to any position within a range of angles from the vertical position to the horizontal position. In some examples, the second monitor support 130 may be able to rotate up to 80 degrees, 90 degrees, 110 degrees, or any other amount from the vertical position. In some examples, the positions available to the second monitor support 130 can be limited by the position of the first monitor support 120. In some examples, the angle of the second monitor support 130 may be manipulated using the base hinge support 108, support linkage 110, and/or support linkage hinge 112, whereby force may be applied to any or all of the aforementioned components, and the couplings between the components may translate the force to each of the components, thus causing the components to move. The base hinge support 108, support linkage 110, and/or support linkage hinge 112 may be manipulated in a similar manner, through the application of force and the transmission of said force through the couplings between the components, to set the angle of the second monitor support 130 and lock the second monitor support 130 into position. Once the user has set the second monitor support 130 to the desired position, the process continues to act 814.

At act 814, the process ends.

The above acts may be performed in any order. For examples, the second monitor support 130 angle may be adjusted first, or the angle of the first monitor support 120 may be adjusted first, and so forth. In the above example, the user does not need to be a person. The user may be a machine, motor, computer-controlled adjustment system, and so forth. That is, the stand 100 may be adjusted, as described with respect to FIG. 8, using a computerized and/or automated system, and/or by a person, and/or so forth.

At any point during, before, or after the acts of the process 800 of FIG. 8, the position of the universal adapters 126, 136 in the adjustment slots 122, 132 may also be adjusted using the fasteners 124, 134 to set the position of the universal adapters 126, 136. A monitor may be attached to the universal adapters 126, 136 at any time, and the acts of the process 800 of FIG. 8 may be performed with or without the universal adapters 126, 136 and/or monitors being attached to the stand 100.

In various examples, the various fasteners (for example, fasteners 124, first fastener 116c, second fastener 116d, third fastener 116e, and so forth) and/or positions (for example, the position of the first monitor support 120 relative to the second hinge 116 or between the vertical and horizontal positions) may be held in place via friction fits requiring a minimum force to overcome. For example, a force of friction of the friction fits may be sufficiently high that the monitor supports 120, 130 do not move in response to the force of gravity. However, the friction force may be sufficiently low that the monitor supports 120, 130 can be moved by a user applying a relatively light force to the monitor supports 120, 130. In some examples, the various fasteners and/or positions may be held in place via locking mechanisms the user can operate (such as nuts, bolts, switches, and so forth) in addition to, or in lieu of, friction fits.

Various controllers, such as the controller of the motors, computer-controller adjustment system, and so forth described above, may execute various operations discussed above. Using data stored in associated memory and/or storage, the controllers may also execute one or more instructions stored on one or more non-transitory computer-readable media, which the controllers may include and/or be coupled to, that may result in manipulated data. In some examples, the controllers may include one or more processors or other types of controllers. In one example, the controllers are or include at least one processor. In another example, the controllers perform at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A stand for one or more monitors comprising:
a base;
a support pillar coupled to the base;
a first hinge coupled between a first monitor support and a second monitor support, the first monitor support being slidably coupled to the support pillar; and
a second hinge coupled to the first monitor support and configured to allow the first monitor support to pivot through a plurality of positions relative to the support pillar.

2. The stand of claim 1 wherein the first monitor support is configured to slidably couple to a first universal adapter and the second monitor support is configured to slidably couple to a second universal adapter.

3. The stand of claim 2 wherein the first universal adapter includes one or more connections configured to be fixedly coupled to a first monitor to slidably couple the first monitor to the first monitor support.

4. The stand of claim 3 wherein the second universal adapter includes one or more connections configured to be fixedly coupled to a second monitor and slidably couple the second monitor to the second monitor support.

5. The stand of claim 1 wherein the first monitor support is configured to be selectively fixed in one or more positions of a plurality of positions between an uppermost position along the support pillar and a lowest position along the support pillar.

6. The stand of claim 5 wherein a position of the second monitor support depends on a respective position of the first monitor support from among the plurality of positions.

7. The stand of claim 6 wherein:
the second monitor support is coupled to a support bar of a support having one or more support bars; and
the second hinge is coupled to a different support bar of the support having one or more support bars.

8. The stand of claim 1 further comprising:
a base hinge support coupled to the base; and
a support bar hingedly coupled to the base hinge support and hingedly coupled to the second monitor support.

9. The stand of claim 1 further comprising a connector coupled between the support pillar and the first monitor support, the connector being configured to slide up and down along one or more guide slots of the support pillar.

10. The stand of claim 1 further comprising a support coupled to the first hinge, the second hinge, and the support pillar, the support being in a fixed orientation relative to the first monitor support and the second monitor support.

11. The stand of claim 10 wherein the support has three support bars including a first support bar, a second support bar, and a third support bar, the first support bar being coupled to the first hinge, the second support bar being coupled to the second hinge, and the third support bar being coupled to the connector.

12. The stand of claim 1 further comprising a first universal adapter coupled to the first monitor support and a second universal adapter coupled to the second monitor support,
wherein the first universal adapter is configured to couple to one or more monitors within a first size range of a first plurality of different sizes, and
the second universal adapter is configured to couple to one or more monitors within a second size range of a second plurality of different sizes.

13. A stand comprising:
a support pillar;
a base coupled to the support pillar;
a first monitor support slidably coupled to the support pillar and configured to selectively maintain a vertical position of a plurality of vertical positions relative to the support pillar, the first monitor support being further configured to rotate to occupy one or more orientations between a vertical orientation and a horizontal orientation, the vertical orientation being approximately parallel to the support pillar and the horizontal orientation being approximately perpendicular to the support pillar; and
a second monitor support hingedly coupled to the first monitor support.

14. The stand of claim 13 wherein the first monitor support includes one or more adjustment slots.

15. The stand of claim 14 further comprising a universal adapter configured to couple to a plurality of monitors of different sizes, the universal adapter being slidably coupled to the first monitor support such that the universal adapter can occupy one or more positions corresponding to the adjustment slots.

16. The stand of claim 13 wherein the second monitor support includes one or more adjustment slots.

17. The stand of claim 16 further comprising a universal adapter configured to couple to a plurality of monitors of different sizes, the universal adapter being slidably coupled to the second monitor support such that the universal adapter can occupy one or more positions corresponding to the adjustment slots.

18. The stand of claim 13 further comprising:
a base hinge support coupled to the base; and
a support bar hingedly coupled to the base hinge support and hingedly coupled to the second monitor support.

19. The stand of claim 13 further comprising a connector coupled between the first monitor support and the support pillar, wherein the connector is rigidly coupled to the first monitor support and slidably coupled to the support pillar.

20. The stand of claim 19 further comprising a support coupled between the connector and the first monitor support, the support having a plurality of support bars.
